(19) United States
(12) Patent Application Publication
(10) Pub. No.: US 2024/0384696 A1
(43) Pub. Date: Nov. 21, 2024

(54) WATER WAVE POWER GENERATING APPARATUS

(71) Applicants: Ta-Hsiung PENG, Kaohsiung City (TW); Kuang-Tsung PENG, Kaohsiung City (TW); Kuang-Chien PENG, Kaohsiung City (TW); Tsun-Chi PENG, Kaohsiung City (TW)

(72) Inventors: Ta-Hsiung PENG, Kaohsiung City (TW); Kuang-Tsung PENG, Kaohsiung City (TW); Kuang-Chien PENG, Kaohsiung City (TW)

(73) Assignees: Ta-Hsiung PENG, Kaohsiung City (TW); Kuang-Tsung PENG, Kaohsiung City (TW); Kuang-Chien PENG, Kaohsiung City (TW); Tsun-Chi PENG, Kaohsiung City (TW)

(21) Appl. No.: 18/317,451

(22) Filed: May 15, 2023

(51) Int. Cl. F03B 13/16

(52) U.S. Cl. CPC F03B 13/16; F05B 2220/706; F05B 2240/40; F05B 2270/202

(57) ABSTRACT

A water wave power generating apparatus includes a power generating device, two buoyant devices and a control device. The power generating device includes a frame unit, an impeller assembly and a power generating unit for converting a wave generated torque of the impeller assembly into electric power. The buoyant devices are swingably disposed at two sides of the power generating device. Each buoyant device includes a pivot end portion pivotally mounted on the frame unit, a swing end portion opposite to the pivot end portion, and buoyant boards interposed between the pivot and swing end portions. The control device is operable to shift the swing end portions between a spread state and a close state so as to avoid damage by water waves.

### FIELD

The disclosure relates to a hydro-electric power generating system, and more particularly to a water wave power generating apparatus for converting water wave into electricity.

### BACKGROUND

There are a variety of ways to generate electric power, such as thermal power, hydraulic power, nuclear power and other power generation methods. Both thermal power and nuclear power generation methods need non-renewable energy sources for power generation, e.g., coal, petroleum, liquefied natural gas, uranium, etc., and these non-renewable energy sources will inevitably be exhausted and cause harm to the environment. Thus, non-renewable energy sources are being replaced by renewable and recyclable energy. The methods of generating electric power can be applied to solar energy, wind power, ocean tides, ocean currents, etc. Efforts have been made to generate electric power from ocean waves. The prior art in Taiwanese Patent No. 1728930, Taiwanese Patent No. M 611454 and Taiwanese Patent No. M574634 show some examples.

### SUMMARY

Therefore, an object of the disclosure is to provide a water wave power generating apparatus that is controllable to avoid damage by ocean waves and provide steady electric power generation.

According to the disclosure, the water wave power generating apparatus includes a power generating device, two buoyant devices and a control device. The power generating device includes a frame unit, an impeller assembly which is pivotally mounted on the frame unit, and a power generating unit which is coupled with the impeller assembly to convert a wave generated torque of the impeller assembly into electric power. The two buoyant devices are respectively and swingably disposed at two sides of the power generating device. Each of the buoyant devices includes a pivot end portion which is pivotally mounted on the frame unit, a swing end portion which is opposite to the pivot end portion, and a plurality of buoyant boards which are interposed between and are interconnecting the pivot end portion and the swing end portion. The control device is operable to shift the swing end portions of the two buoyant devices between a spread state where the swing end portions are remote from each other, and a close state where the swing end portions are close to each other. The control device includes a pontoon which is positioned relative to the frame unit, a primary electric cable winder which is mounted on the pontoon, a primary transmitting cable which is driven by and wound around the primary electric cable winder, and two lateral transmitting units each of which interconnects the primary transmitting cable and the swing end portion of a respective one of the buoyant devices. The two lateral transmitting units intersect at an end of the primary transmitting cable to define an angle which is varied when winding of the primary transmitting cable by the primary electric cable winder to shift the swing end portions of the buoyant devices between the spread state and the close state through the lateral transmitting units.

According to the level of and intensity of wind and waves, the control device can automatically control the shifting of the buoyant devices to avoid damage to the water wave power generating apparatus and prolong the service life thereof.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is a perspective view illustrating an embodiment of a water wave power generating apparatus according to the disclosure in a state when swing end portions of two buoyant devices are in a spread state.

FIG. 2 is a perspective view illustrating a power generating device of the embodiment.

FIG. 3 is a fragmentary schematic view illustrating the buoyant device of the embodiment.

FIG. 4 is an exploded perspective view illustrating a portion of the buoyant device of the embodiment.

FIG. 5 is a perspective view illustrating a buoyant board of the buoyant device of the embodiment.

FIG. 6 is a fragmentary perspective view of the buoyant device of the embodiment.

FIG. 7 is a fragmentary perspective view of a control device of the embodiment.

FIG. 8 is a schematic plan view of the control device of the embodiment.

FIG. 9 is a fragmentary perspective view illustrating a data collecting unit of the control device mounted on the buoyant device.

FIG. 10 is an exploded perspective view illustrating a lateral transmitting unit of the control device having a plurality of tubular discs and a plurality of resilient elements.

FIG. 11 is a fragmentary perspective view of the lateral transmitting unit.

FIG. 12 is a perspective view illustrating the water wave power generating apparatus in a state when swing end portions of two buoyant devices are in a close and downward state.

FIG. 13 is a perspective view illustrating a power generating device of the embodiment in a modified form.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

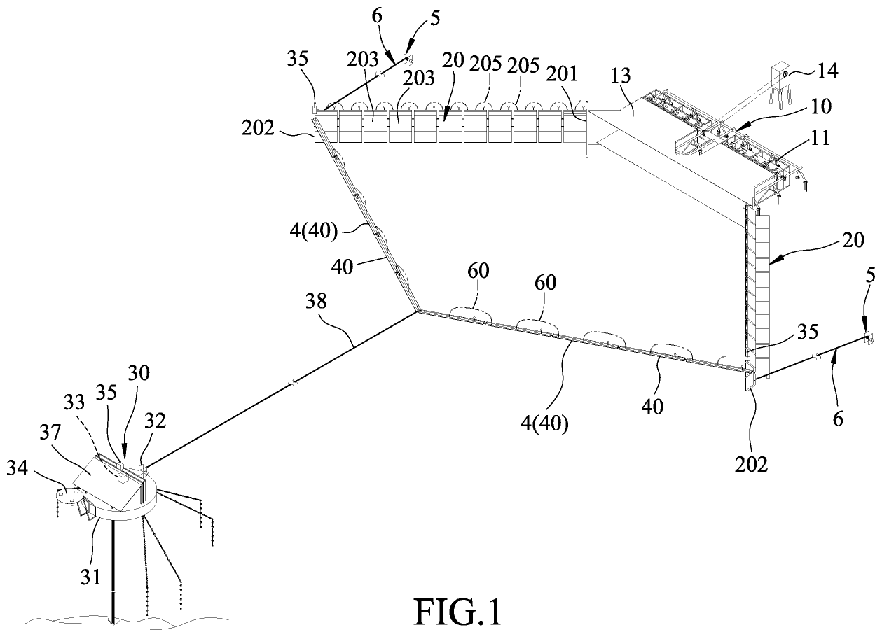

Referring to FIG. 1, an embodiment of a water wave power generating apparatus according to the disclosure is adapted to be mounted at an intertidal zone on the coast, and includes a power generating device 10, two buoyant devices 20 and a control device 30.

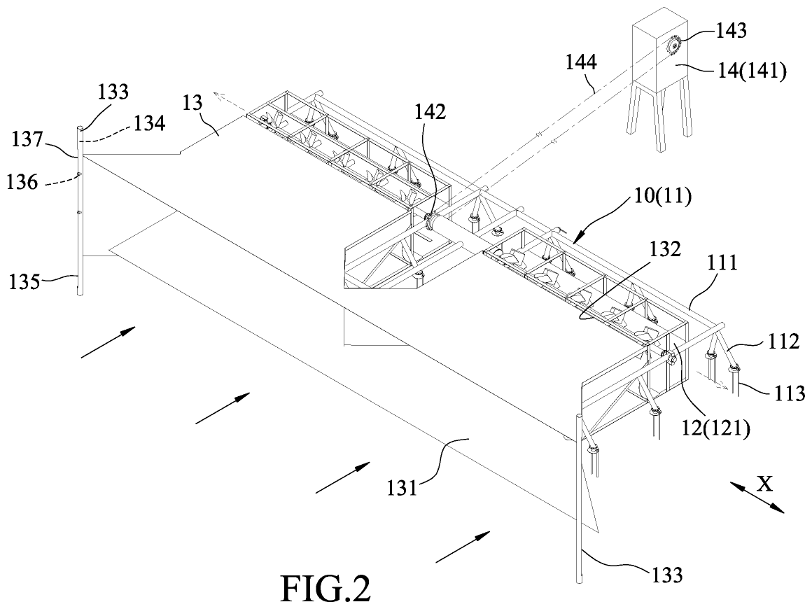

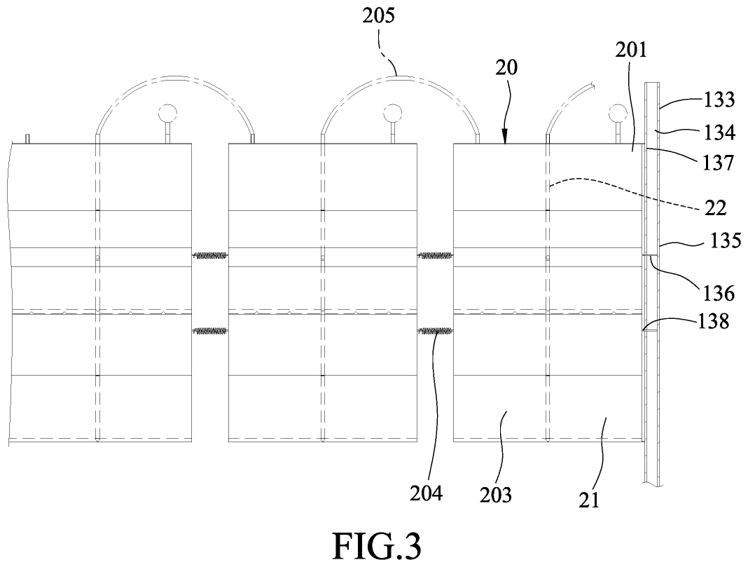

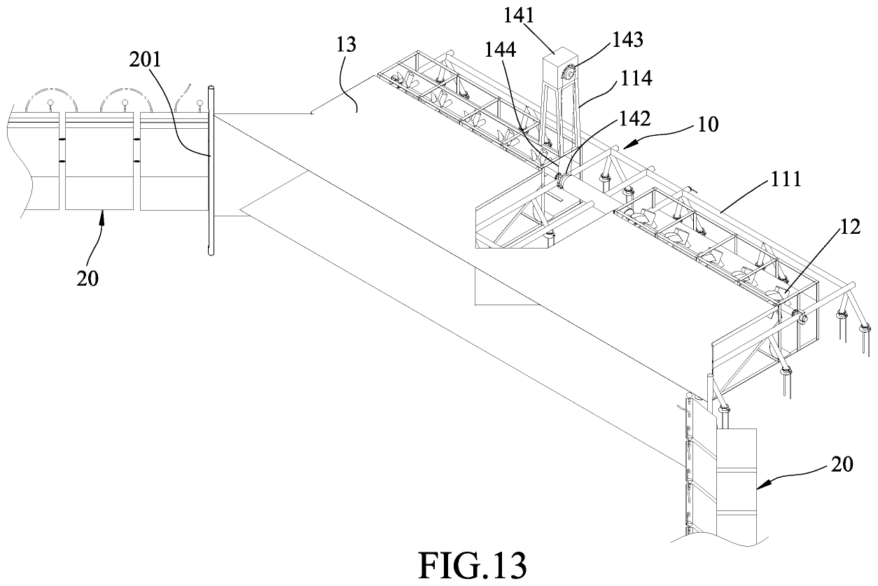

With reference to FIG. 2, the power generating device 10 includes a frame unit 11, an impeller assembly 12 which is pivotally mounted on the frame unit 11, a wave guiding unit 13 which is mounted on the frame unit 11, and a power generating unit 14 which is coupled with the impeller assembly 12 to convert a wave generated torque of the impeller assembly 12 into electric power. The frame unit 11 includes a main frame 111, a plurality of support posts 112 connected with the main frame 111, and a plurality of ground anchors 113 securing the support posts 112 to the intertidal zone. The impeller assembly 12 has a plurality of turbine impellers 121 arranged in an axial direction (X). The turbine impellers 121 are disposed on two opposite sides of the main frame 111 and in opposite mounted directions. The wave guiding unit 13 is mounted at a forward side of the frame unit 11, and is in the form of a funnel to have a wave entering end 131 and a wave outlet end 132 opposite to the wave entering end 131 in a wave ascending direction (as indicated by the arrows in FIG. 2) and proximal to the impeller assembly 12. The wave guiding unit 13 is configured to gradually taper from the wave entering end 131 to the wave outlet end 132. The wave guiding unit 13 has two hollow upright posts 133 which are disposed at the wave entering end 131. Each upright post 133 has a tubular wall 135 which defines a sliding hole 134, and two sliding blocks 136 slidably disposed in the sliding hole 134. The tubular wall 135 has a slit 137 formed therethrough and in communication with the sliding hole 134 such that each sliding block 136 has a connecting portion 138 extending outwardly of the slit 137, as shown in FIG. 3. In this embodiment, the power generating unit 14 includes a power generator 141 of a known type which is disposed on a shore, a driving chainwheel 142 which is coaxially mounted with the impeller assembly 12, a driven chainwheel 143 which is coupled with the power generator 141, and a chain 144 which is trained on the driving chainwheel 142 and the driven chainwheel 143. Alternatively, as shown in FIG. 13, in a modified form of the power generating unit 14, a mounting rack 114 is connected with and extends upwardly from the main frame 111. The power generating unit 14 includes a power generator 141 which is mounted on a top of the mounting rack 114, a driving chainwheel 142 which is coaxially mounted with the impeller assembly 12, a driven chainwheel 143 which is coupled with the power generator 141, and a chain 144 which is trained on the driving chainwheel 142 and the driven chainwheel 143.

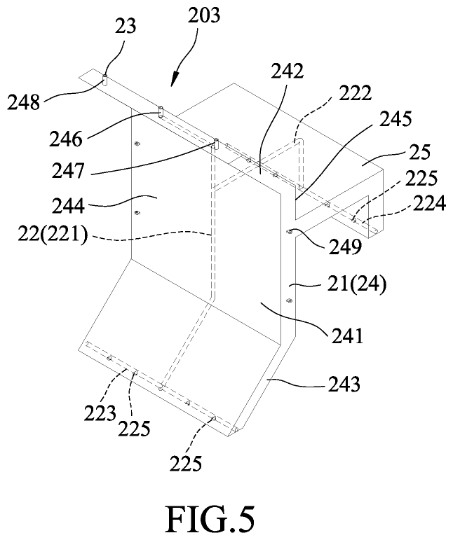

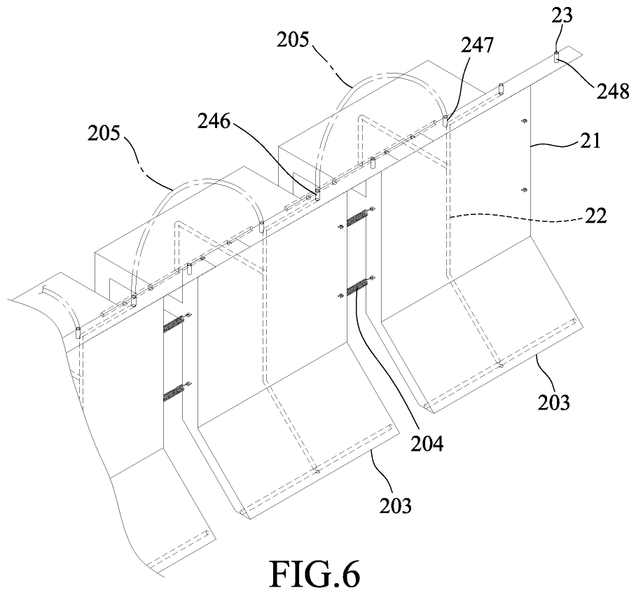

With reference to FIGS. 3 to 6, the two buoyant devices 20 are respectively and swingably mounted on the upright posts 133 of the power generating device 10. Each of the buoyant devices 20 includes a pivot end portion 201 which is pivotally mounted on the frame unit 11, a swing end portion 202 which is opposite to the pivot end portion 201, a plurality of buoyant boards 203 which are interposed between and interconnect the pivot end portion 201 and the swing end portion 202, a plurality of resilient elements 204 each of which is connected between two adjacent ones of the buoyant boards 203, and a plurality of connecting pipes 205.

Each of the buoyant boards 203 has a hollow buoyant body 21, a conduit 22 which is disposed within and extends through the buoyant body 21, and a safety valve 23 which is mounted on the buoyant body 21 to permit air or water to be introduced into the buoyant body 21 to control buoyancy of the buoyant board 203. Specifically, the buoyant body 21 of each buoyant board 203 has an upright main body 24 and a balance wing 25 which is connected with and in spatial communication with an outboard side of the upright main body 24. The upright main body 24 has an upright middle section 241, an upper section 242 which extends upwardly at an incline from the middle section 241 toward the other buoyant device 20, a lower section 243 which extends downwardly from the middle section 241 at an incline toward the other buoyant device 20, and two pairs of lugs 249 which are disposed at two sides of the middle section 241, respectively. The middle section 241 has an inboard surface 244 and an outboard surface 245 opposite to each other. The upper section 242 of each buoyant board 203 has an upper conduit hole 246 which is formed in a top thereof, a first conduit joint 247 which is formed at one side of the upper conduit hole 246, and a second conduit joint 248 which is formed at an opposite side of the upper conduit hole 246. The balance wing 25 is of an inverse L-shape and extending from the outboard surface 245 of the middle section 241. The conduit 22 has a main conduit section 221 which extends from the upper section 242 to the lower section 243 and which is in communication with the upper conduit hole 246, a branch conduit section 222 which is in communication with the main conduit section 221 and which extends from the middle section 241 along the balance wing 25 to a lower end of the balance wing 25, a lower outlet conduit section 223 which is in communication with the main conduit section 221 and which is disposed in a lower end of the lower section 243, and a lateral outlet conduit section 224 which is in communication with the branch conduit section 222 and which is disposed in the lower end of the balance wing 25. Each of the lower outlet conduit section 223 and the lateral outlet conduit section 224 has a plurality of spouts 225. The safety valve 23 is mounted on the second conduit joint 248. Each resilient element 204 is connected with two lugs 249 of the two adjacent buoyant boards 203. The lugs 249 of the buoyant boards 21 adjacent to the two upright posts 133 are pivotally connected with the connecting portions 138 of the sliding blocks 136, respectively. Each connecting pipe 205 interconnects the first conduit joint 247 of one buoyant board 203 and the upper conduit hole 246 of the adjacent buoyant board 203 to intercommunicate the buoyant boards 203 with each other. Thus, air or water can be introduced into the buoyant bodies 21 through the connecting pipes 205 and the conduits 22 to control the buoyancy of the buoyant boards 203 and the level of submersion of the buoyant boards 203 floating on the ocean.

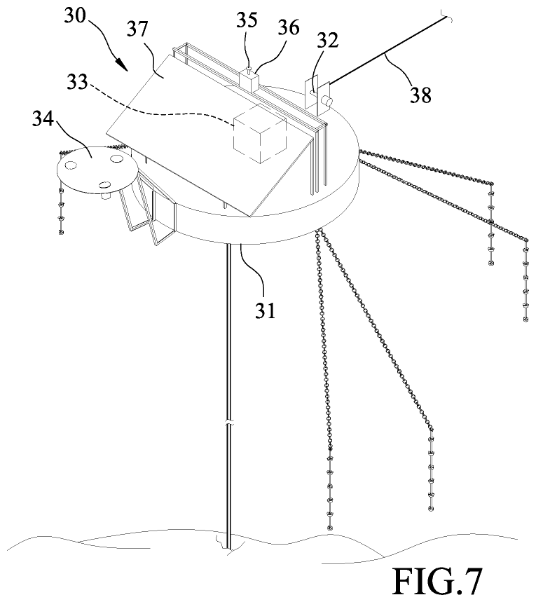

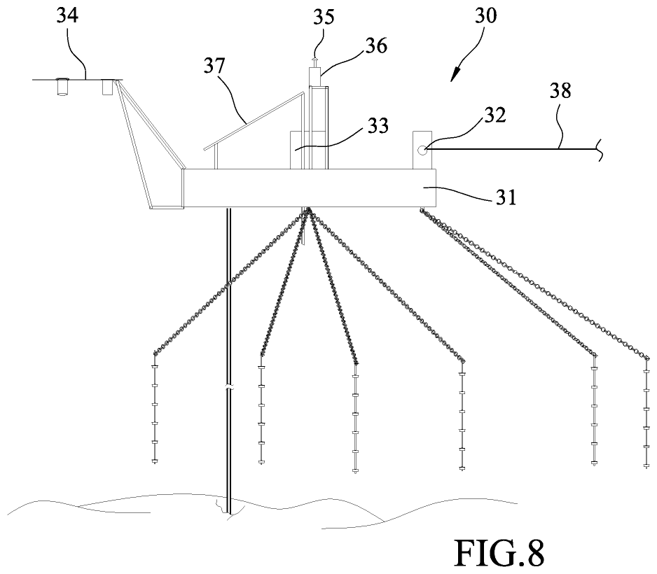

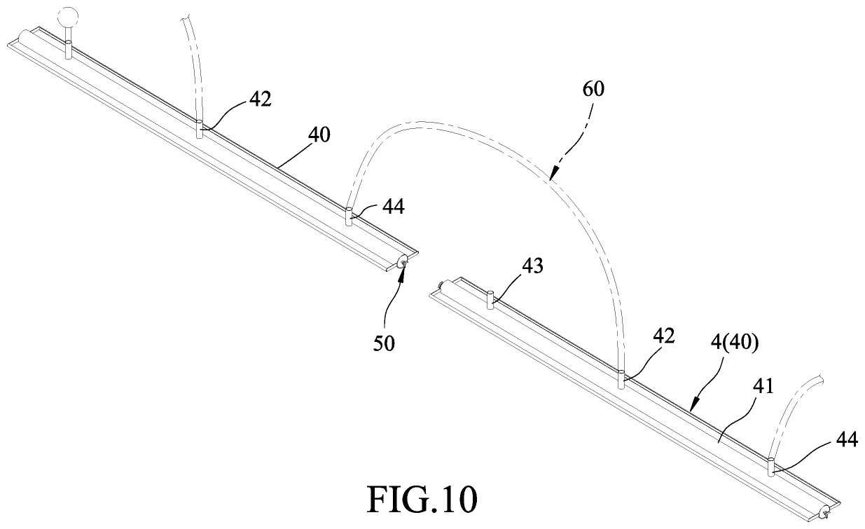

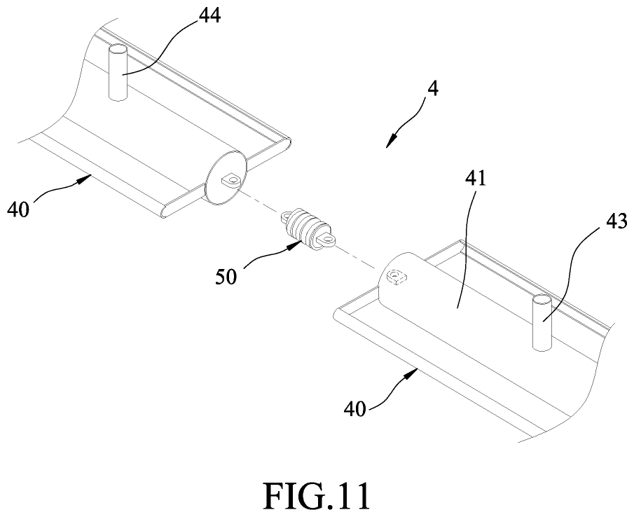

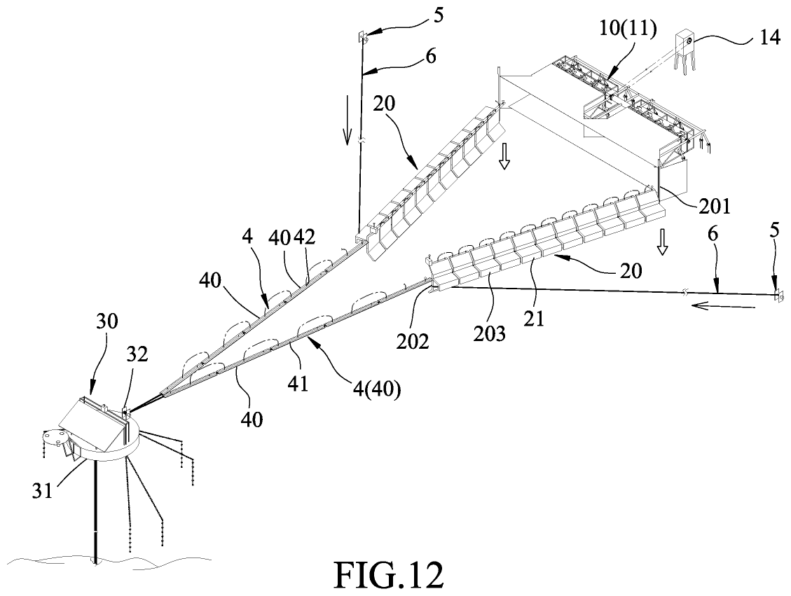

The control device 30 is operable to shift the swing end portions 202 of the two buoyant devices 20 between a spread state (as shown in FIG. 1), where the swing end portions 202 are remote from each other, and a close state (as shown in FIG. 12), where the swing end portions 202 are close to each other. With reference to FIG. 1 and FIGS. 7 to 11, the control device 30 includes a pontoon 31 which is positioned opposite relative to the frame unit 11, a primary electric cable winder 32 which is mounted on the pontoon 31, a control operating unit 33 which is mounted on the pontoon 31, a wave and tide gauge 34 which is electrically connected with the control operating unit 33 to measure sea levels and generate a wave data signal, three data collecting units 35 which are respectively mounted on the pontoon 31 and the swing end portions 202 to receive and confirm their locations and generate a location signal, a chassis 36 which is mounted on the pontoon 31 for mounting a processing board and a storage battery thereon, a solar panel 37 which is mounted on the pontoon 31 to generate electric energy that is stored in the storage battery, a primary transmitting cable 38 which is wound around and driven by the primary electric cable winder 32, two lateral transmitting units 4 each of which interconnects the primary transmitting cable 38 and the swing end portion 202 of the respective buoyant device 20, two auxiliary electric cable winders 5 which are respectively and securely disposed at the two sides of the power generating device 10, and two auxiliary transmitting cables 6 which are respectively wound around and driven by the auxiliary electric cable winders 5. Each auxiliary transmitting cable 6 has an end connected with the swing end portion 202 of the respective buoyant device 20. The auxiliary electric cable winders 5 and the primary electric cable winder 32 are operated synchronously such that the auxiliary electric cable winders 5 unwind the auxiliary transmitting cables 6 when the primary electric cable winder 32 winds the primary transmitting cable 38, and that the auxiliary electric cable winders 5 wind the auxiliary transmitting cables 6 when the primary electric cable winder 32 unwinds the primary transmitting cable 38. The control operating unit 33 receives the wave data signal from the wave and tide gauge 34 and the location signal from the data collecting units 35, which are processed by the processing board to obtain a relative location between the data collecting units 35. When a wave data measured by the wave and tide gauge 34 is higher than a predetermined value, the control operating unit 33 controls and drives the the primary electric cable winder 32 to wind the primary transmitting cable 38 and the auxiliary electric cable winders 5 to unwind the auxiliary transmitting cables 6. When a wave data measured by the wave and tide gauge 34 is lower than a predetermined value, the control operating unit 33 controls and drives the primary electric cable winder 32 to unwind the primary transmitting cable 38 and the auxiliary electric cable winders 5 to wind the auxiliary transmitting cables 6. Each of the data collecting units 35 has a long-term replaceable battery attached thereto.

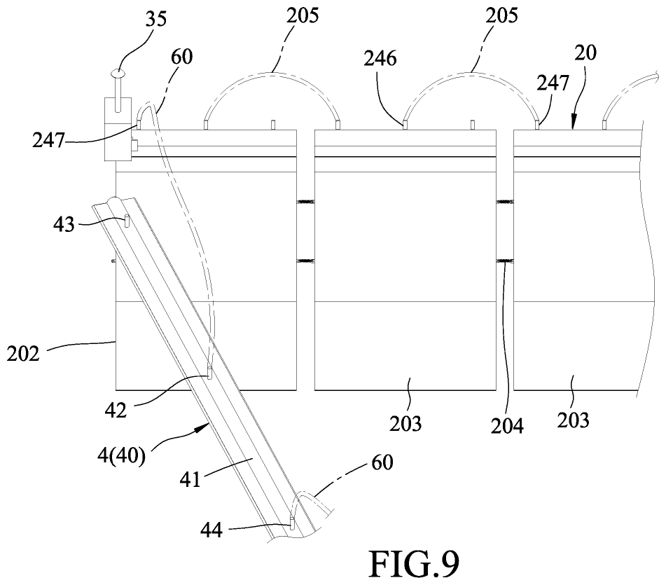

Each lateral transmitting unit 4 has a plurality of tubular discs 40 which are interposed between the primary transmitting cable 38 and the swing end portion 202, a plurality of resilient elements 50, each of which is connected between two adjacent ones of the tubular discs 40, and a plurality of engaging pipes 60. Each tubular disc 40 has a hollow disc body 41, an introducing pipe 42 which extends into the disc body 42 from an upper portion of the disc body 41, a safety valve 43 which is mounted on the upper portion of the disc body 41, and an upper connecting hole 44 which is formed in the upper portion of the disc body 41. Each engaging pipe 60 interconnects the introducing pipe 42 of one tubular disc 40 and the upper connecting hole 44 of the adjacent tubular disc 40 to intercommunicate the tubular discs 40 with each other. Air or water can be introduced from the introducing pipe 42 into the disc body 41 through the engaging pipes 60 to control the buoyant force of the tubular discs 40 and the level of submersion of the tubular discs 40 when floating in the ocean. In addition, an engaging pipe 60 may interconnect the introducing pipe 42 of a tubular disc 40 adjacent to the swing end portion 202 and the first conduit joint 247 of the buoyant board 203 such that the tubular discs 40 and the corresponding buoyant boards 203 intercommunicate with each other, as shown in FIG. 9.

FIG. 1 illustrates the power generating apparatus in a state adapted for relatively gentle wind and waves. Through the wave and tide gauge 34 measuring a wave data which is lower than the predetermined value, the control unit 33 controls and drives the primary electric cable winder 32 to unwind the primary transmitting cable 38 such that a wider space is created between the swing end portions 202 of the two buoyant devices 20 and the swing end portions 202 are shifted to a spread out state where the swing end portions 202 are remote from each other. In this state, the buoyant devices 20 are formed as a funnel with a wide opening for facilitating collection of sea waves toward the wave guiding unit 13. The collected sea waves are guided by the wave guiding unit 13 and impact impeller assembly 12 which generates a torque that is converted by the power generating unit 14 into electric power. With the turbine impellers 121 of the impeller assembly 12, water waves that flow in the wave ascending direction (as indicated by solid arrows in FIG. 2) and are converted to flow in a water expelling direction (as indicated by dotted arrows in FIG. 2) transverse to the wave ascending direction. With the turbine impellers 121 mounted in opposite mounted directions on two sides of the main frame 111, the power generating device 10 is mounted in a balanced and steady manner.

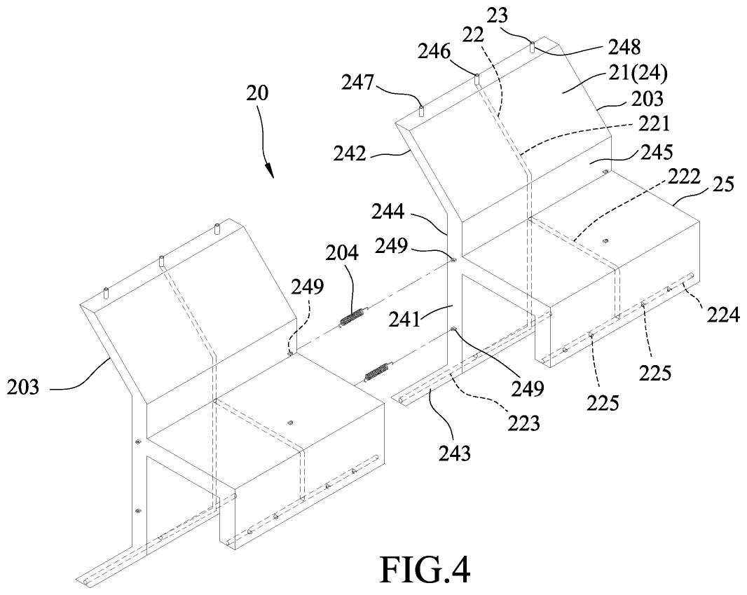

In the state shown in FIG. 1, and with reference to FIGS. 4 to 6, once there is water in the buoyant bodies 21 to make them submerged, air can be introduced into the buoyant bodies 21 through the connecting pipes 205 and the conduits 22 (e.g., by an air compressor mounted on the shore (not shown)). Air ejected from the spouts 225 in each of the lower outlet conduit section 223 and the lateral outlet conduit section 224, can guide water in one buoyant body 21 to flow to the next buoyant board 21 through the connecting pipes 205, and can be discharged outward from the distal buoyant body 21 until the buoyant bodies 21 are completely filled with air. Thus, the buoyant boards 203 are controlled to float up. Meanwhile, air can be introduced into the disc bodies 41 of the tubular discs 40 of the lateral transmitting units 4 through the introducing pipes 42 to control the tubular discs 40 to float up.

Referring to FIG. 12, when the wave and tide gauge 34 measures a wave data which is higher than the predetermined value, the control unit 33 controls and drives the primary electric cable winder 32 to wind the primary transmitting cable 38 and move the lateral transmitting units 4, such that an angle of the lateral transmitting units 4, which is defined at an end of the primary transmitting cable 38 where the two lateral transmitting units 4 intersect, is varied to shift the swing end portions 202 of the buoyant devices 20 to the close state where the swing end portions 202 are close to each other.

In the state shown in FIG. 12, and with reference to FIGS. 4 to 6, once there is air filled in the buoyant bodies 21, sea water can be introduced into the buoyant bodies 21 through the connecting pipes 205 and the conduits 22 (e.g., by a pumping equipment mounted on the shore (not shown)). Water ejects from the spouts 225 in each of the lower outlet conduit section 223 and the lateral outlet conduit section 224, and air in one buoyant body 21 can be expelled to the next buoyant board 21 through the connecting pipes 205 until the buoyant bodies 21 are filled with water. Thus, the buoyant boards 203 are controlled to increase their weight and sink down, which prevents the buoyant devices 20 from being damaged by the impact of rough waves, and prolongs the service life of the power generation apparatus. Meanwhile, water can be introduced into the disc bodies 41 of the tubular discs 40 of the lateral transmitting units 4 through the introducing pipes 42 to control the tubular discs 40 to sink down.

Specifically, with the resilient elements 204 connected between the buoyant boards 203 of the buoyant devices 20, waves impacting the buoyant devices 20 which may cause deformation thereof can be absorbed to further prevent damage to the buoyant devices 20. Similarly, with the resilient elements 50 connected between the tubular discs 40 of the lateral transmitting units 4, impact on the lateral transmitting units 4 can be absorbed to prevent damage to the same. Moreover, the buoyant boards 203 are controlled to float or sink through the introduction of air or sea water thereinto, and the tubular discs 40 are controlled to float or sink through the introducing of air or sea water thereinto, impact of waves on the apparatus can be minimized, and air and sea water are inexhaustible resources that reduce the operating cost. Furthermore, the control device 30 is operated to shift the swing end portions 202 of the two buoyant devices 20 between the spread state and the close state. Also, with the precise measurement and monitoring of the sea level by the wave and tide gauge 34, and the data collecting units 35 receiving and ensuring their locations, the wave data signal from the wave and tide gauge 34 and the location signal from the data collecting units 35 are processed to obtain a relative location between the data collecting units 35. Thus, the operation time of shifting the swing end portions 202 between the spread state and the close state can be precisely controlled, and the operation control can be automatic and easy to perform.

It is noted that the power generator 141 of the power generating unit 14 can be mounted on a shore (see FIG. 2), or can be elevated to be mounted on a rack (see FIG. 13) to prevent the power generator 141 from being eroded by sea water and prolong the service life thereof.

As illustrated, the water wave power generating apparatus of the present invention can stabilize power generation and prolong the service life.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A water wave power generating apparatus comprising:
a power generating device including a frame unit, an impeller assembly which is pivotally mounted on said frame unit, and a power generating unit which is coupled with said impeller assembly to convert a wave generated torque of said impeller assembly into electric power;
two buoyant devices respectively and swingably disposed at two sides of said power generating device, each of said buoyant devices including a pivot end portion which is pivotally mounted on said frame unit, a swing end portion which is opposite to said pivot end portion, and a plurality of buoyant boards which are interposed between and interconnecting said pivot end portion and said swing end portion; and
a control device operable to shift said swing end portions of said two buoyant devices between a spread state where said swing end portions are remote from each other, and a close state where said swing end portions are close to each other, said control device including a pontoon which is positioned opposite relative to said frame unit, a primary electric cable winder which is mounted on said pontoon, a primary transmitting cable which is driven by and wound around said primary electric cable winder, and two lateral transmitting units each of which interconnects said primary transmitting cable and said swing end portion of a respective one of said buoyant devices, said two lateral transmitting units intersecting at an end of said primary transmitting cable to define an angle which is varied when winding of said primary transmitting cable by said primary electric cable winder to shift said swing end portions of said buoyant devices between the spread state and the close state through said lateral transmitting units.

2. The water wave power generating apparatus of claim 1, wherein said control device further includes two auxiliary electric cable winders which are respectively and securely disposed at said two sides of said power generating device, and two auxiliary transmitting cables which are respectively driven by and wound around said auxiliary electric cable winders, each of said auxiliary transmitting cables having an end connected with said swing end portion of the respective one of said buoyant devices, said auxiliary electric cable winders and said primary electric cable winder being operated synchronously such that said auxiliary electric cable winders unwind said auxiliary transmitting cables when said primary electric cable winder winds said primary transmitting cable, and that said auxiliary electric cable winders wind said auxiliary transmitting cables when said primary electric cable winder unwinds said primary transmitting cable.

3. The water wave power generating apparatus of claim 2, wherein said control device further includes a control operating unit which is mounted on said pontoon, a wave and tide gauge which is electrically connected with said control operating unit to measure sea levels and generate a wave data signal, three data collecting units which are respectively mounted on said pontoon and said swing end portions to receive and ensure their locations to generate a location signal, a chassis which is mounted on said pontoon for mounting a processing board and a storage battery thereon, and a solar panel which is mounted on said pontoon to generate electric energy that is stored in said storage battery, each of said data collecting units having a long-term replaceable battery attached thereto, said control operating unit receiving the wave data signal and the location signal which are processed by said processing board to obtain a relative location between said data collecting units such that, when a wave data measured by said wave and tide gauge is higher than a predetermined value, said control operating unit controls and drives the winding of said primary electric cable winder to wind said primary transmitting cable, and that, when a wave data measured by said wave and tide gauge is lower than a predetermined value, said control operating unit controls and drives the unwinding of said primary electric cable winder to unwind said primary transmitting cable.

4. The water wave power generating apparatus of claim 1, wherein each of said buoyant devices further includes a plurality of resilient elements connected between two adjacent ones of said buoyant boards.

5. The water wave power generating apparatus of claim 1, wherein each of said buoyant boards has a hollow buoyant body, a conduit which is disposed within and extends through said buoyant body, and a safety valve which is mounted on said buoyant body to permit air or water to be introduced into said buoyant body to control a buoyant force of said buoyant board.

6. The water wave power generating apparatus of claim 5, wherein said buoyant body of each of said buoyant boards has an upright main body and a balance wing which is connected with and in spatial communication with an outboard side of said upright main body, said upright main body having an upright middle section, an upper section which extends upwardly from and is inclined relative to said middle section toward the other one of said buoyant devices, and a lower section which extends downwardly from and is inclined relative to said middle section toward the other one of said buoyant devices, said balance wing being of an inverse L-shape and extending from an outboard surface of said upright middle section, said conduit having a main conduit section which extends from said upper section to said lower section, a branch conduit section which is in communication with said main conduit section and which extends from said middle section along said balance wing to a lower end of said balance wing, a lower outlet conduit section which is in communication with said main conduit section and which is disposed in a lower end of said lower section, and a lateral outlet conduit section which is in communication with said branch conduit section and which is disposed in said lower end of said balance wing, each of said lower outlet conduit section and said lateral outlet conduit section having a plurality of spouts.

7. The water wave power generating apparatus of claim 5, wherein said buoyant body of each of said buoyant boards has an upper conduit hole which is formed in an upper section thereof, a first conduit joint which is formed at one side of said upper conduit hole, and a second conduit joint which is formed at an opposite side of said upper conduit hole, each of said buoyant devices further including a plurality of connecting pipes, each of which interconnecting said first conduit joint of one of said buoyant boards and said upper conduit hole of an adjacent one of said buoyant boards to intercommunicate said buoyant boards with each other, said safety valve being mounted on said second conduit joint.

8. The water wave power generating apparatus of claim 1, wherein each of said lateral transmitting units of said control device has a plurality of tubular discs which are interposed between said primary transmitting cable and said swing end portion, and a plurality of resilient elements, each of which is connected between two adjacent ones of said tubular discs, each of said tubular discs having a hollow disc body, an introducing pipe which extends into said disc body, and a safety valve which is mounted on said disc body to permit air or water to be introduced from said introducing pipe into said disc body to control a buoyant force of said tubular disc.

9. The water wave power generating apparatus of claim 8, wherein each of said tubular discs further has an upper connecting hole which is formed in an upper portion of said disc body, said control device further including a plurality of engaging pipes, each of which interconnecting said introducing pipe of one of said tubular discs and said upper connecting hole of an adjacent one of said tubular discs to intercommunicate said tubular discs with each other.
